(19) United States
(12) Patent Application Publication
(10) Pub. No.: US 2018/0211352 A1
(43) Pub. Date: Jul. 26, 2018

(54) METHOD AND SYSTEM FOR INTERMEDIATING USER TERMINALS TO SHARE VEHICLES

(71) Applicants: NHN Entertainment Corporation, Seongnam-si (KR); NHN Studio629 Corporation, Seongnam-si (KR)

(72) Inventor: Chuljae Lim, Seongnam-si (KR)

(21) Appl. No.: 15/880,410

(22) Filed: Jan. 25, 2018

(30) Foreign Application Priority Data
Jan. 26, 2017 (KR) 10-2017-0012518

(51) Int. Cl. G06Q 50/30; G06Q 10/02

(52) U.S. Cl. CPC G06Q 50/30; G06Q 30/0277; G06Q 10/02

(57) ABSTRACT

A method of providing intermediating service between terminals to share vehicles, the method including: receiving departure point information, destination information, a time the vehicle provider is leaving work, set-up information, and condition information from terminals, matching and registering the received information with identifier information of the provider terminal and the user terminal; receiving intermediation request from the terminals; determining user terminal and provider terminal among the terminals matching each other based on the registered departure point information, the destination information, the time the user is leaving work, the set-up information, and the condition information of the terminals that transmitted the intermediation request; providing information of the matched user terminal to the matched provider terminal; and providing information of the matched provider terminal to the matched user terminal.

### CROSS-REFERENCE TO RELATED APPLICATION

This application claims priority from and the benefit of Korean Patent Application No. 10-2017-0012518, filed on Jan. 26, 2017, which is hereby incorporated by reference for all purposes as if fully set forth herein.

### BACKGROUND

### Field

Exemplary embodiments/implementations of the invention relate generally to a technology for sharing vehicles, and more specifically, to a method and system for intermediating between a vehicle provider and a vehicle passenger to share vehicles from a departure point to a destination.

### Discussion of the Background

As highly efficient portable devices such as a smart phone have recently appeared, user convenience functions have increased, such as public transportation guidance, automobile navigation, and the like. Furthermore, there are various applications for public transportation, and users may easily confirm where a bus that the user wants to take is located.

Users generally use public transportation for a faster commute. However, because most people have substantially similar travelling schedules during the rush hour around 9 a.m. and 6 p.m., public transportation very easily gets congested from 7 a.m. to 9:30 a.m. and from 5:30 p.m. to 7 p.m., and the subway may get very overcrowded with subway passengers. Accordingly, considerable numbers of commuters are driving to avoid the overcrowded public transportation during the rush hour.

Furthermore, people generally have better public transportation option going to work. However, in the case of people leaving work, the time that people leave work varies, and they may even miss the last train or bus after working too late.

Therefore, a technology for intermediating (i.e. matching) users who are leaving work with people driving home has been considered. Korean Patent Publication No. 10-2012-0075616 relates to a service providing method for carpooling using location-based services, and discloses a technology for mediating carpool service by receiving a request for mediating a carpool from a carpool provider terminal and a user terminal, and using carpooling by confirming locations of others by transmitting location information of others using the location-based service.

The above information disclosed in this Background section is only for understanding of the background of the inventive concepts, and, therefore, it may contain information that does not constitute prior art.

### SUMMARY

Devices constructed and methods according to exemplary embodiments of the invention are capable of intermediating user terminals to share vehicles after work which may decrease traffic congestion and decrease vehicle maintenance costs.

Particularly, the devices constructed and methods according to exemplary embodiments of the invention are capable of intermediating and matching user terminals leaving work at substantially similar times to share vehicles between a vehicle provider and a vehicle passenger, and modify the time the users leave work in response to the failure of matching, and providing a reward to modifying the provided time the user is leaving work.

According to one or more exemplary embodiments of the invention, a method of providing intermediating service between terminals including at least one provider terminal of a vehicle provider and at least one user terminal of a vehicle passenger to share vehicles executed by a computer is provided. The method includes: receiving departure point information, destination information, a time the vehicle provider is leaving work, set-up information, and condition information from terminals, matching and registering the received information with identifier information of the at least one provider terminal and the at least one user terminal; receiving an intermediation request from the terminals; determining at least one user terminal and at least one provider terminal among the terminals matching each other based on the registered departure point information, the destination information, the time the user is leaving work, the set-up information, and the condition information of the terminals that transmitted the intermediation request; providing information of the matched at least one user terminal to the matched at least one provider terminal; and providing information of the matched at least one provider terminal to the matched at least one user terminal.

The determining may include: calculating matching possibility for time slots apart from the time the user is leaving work of the user terminal and the provider terminal for every predefined time unit, in response to failing to match at least one user terminal and at least one provider terminal; and providing the calculated matching possibility for each time slots to the user terminal and the provider terminal.

The method may further include: providing a reward for modifying time the user is leaving work in response to the at least one user terminal and the at least one provider terminal modifying the time the user is leaving work based on the received matching possibility for each time slots.

The terminals are determined to be one of a provider terminal of a vehicle provider or a user terminal of a vehicle passenger in response to the corresponding set-up information.

The determining may include matching at least one provider terminal and at least one user terminal which have closest matching time the user is leaving work in response to failing to match at least one user terminal and at least one provider terminal.

The method may further include: providing information regarding alternative route home in response to failing to match at least one user terminal and at least one vehicle provider, including providing information relating to available taxis and off-duty vehicles service determined based on the departure point information, destination information, and time the user is leaving work of the user terminal.

The determining includes: determining pick up location and destination of the at least one user terminal based on the departure point information and destination information of the user terminal and relevant traffic regulations, and providing the determined pick up location and destination of the at least one user terminal to the at least one user terminal and the at least one provider terminal.

The method may further include: counting the number of view of provided advertisement in the user terminal; and determining whether to provide a reward including riding discount coupon and free riding coupon, based on the counted number of view of advertisement.

The determining includes calculating remaining seat information, including: counting the number of at least one user terminal determined to ride the vehicle through matching with the at least one provider terminal, and calculating remaining seat information based on vehicle capacity information received from the at least one provider terminal and the counted number of user terminal, and the providing the calculated remaining seat information of the matched at least one provider terminal to the matched at least one user terminal.

The determining includes: determining terminals that had been successfully matched equal to or greater than a predefined certain frequency based on the past use history of the at least one provider terminal and the at least one user terminal; and registering the determined terminal as designated ride share members by confirming whether the users of the determined terminals accept to register each other as the designated ride share members.

According to one or more exemplary embodiments of the invention, a system for intermediating user terminals to share vehicles, the system may include: at least one processor implemented to execute computer readable instructions, and the at least one processor includes: a registering circuit configured to: receive departure point information, destination information, time a user is leaving work, set-up information, and condition information from terminals including a provider terminal and a user terminal to share a provider vehicle with other people, match the information with identifier information of corresponding terminals, and register the matched information; a determining circuit configured to determine at least one user terminal and at least one provider terminal matching each other based on the departure point information, the destination information, the time the user is leaving work, the set-up information, and the condition information of the terminals that transmitted an intermediation request; and an information providing circuit configured to provide information of the matched at least one user terminal and the matched at least one provider terminal to each other.

The determining circuit may be configured to calculate matching possibility for time slots apart from the time the user is leaving work of the user terminal and the provider terminal for every predefined time unit, in response to failing to match at least one user terminal and the at least one provider terminal, and wherein the information providing circuit may be configured to provide the calculated matching possibility for each hour to the user terminal or the provider terminal.

The system may further include a reward providing circuit configured to provide a reward for modifying time the user is leaving work in response to the at least one user terminal and the at least one provider terminal modifying the time the user is leaving work based on the received matching possibility for each time slots.

The determination circuit may be configured to determine whether the terminals are one of a provider terminal of a vehicle provider or a user terminal of a vehicle passenger in response to the corresponding set-up information.

The determining circuit may be configured to match at least one provider terminal and at least one user terminal which have closest matching time the user is leaving work in response to failing to match at least one user terminal and at least one provider terminal.

The information providing circuit may be configured to provide information regarding alternative route home in response to failing to match at least one user terminal and at least one vehicle provider, including relating to available taxis and off-duty vehicles service determined based on the departure point information, destination information, and time the user is leaving work of the user terminal when matching of the user terminal.

The determining circuit may be configured to determine pick up location and destination of the at least one user terminal based on the departure point information and destination information of the user terminal and relevant traffic regulations, and the information providing unit is configured to provide the determined pick up location and destination of the at least one user terminal to the at least one user terminal and the at least one provider terminal.

The system may further include a reward providing circuit configured to count the number of view of provided advertisement in the user terminal and determine whether to provide a reward including riding discount coupon and free riding coupon, based on the counted number of view of advertisement.

The determining circuit may be configured to calculate remaining seat information by counting the number of at least one user terminal determined to ride the vehicle through matching with the at least one provider terminal, and calculating remaining seat information based on vehicle capacity information received from the alt east one provider terminal and the counted number of user terminal, and wherein the information providing circuit may be configured to provide the calculated remaining seat information of matched at least one provider terminal to the matched at least one user terminal.

The determining circuit may be configured to: determine terminals that had been successfully matched equal to or greater than a predefined certain frequency based on the past use history of the at least one provider terminal and the at least one user terminal, and register the determined terminal as designated ride share members by confirming whether the users of the determined terminals accept to register each other as the designated ride share members.

Additional features of the inventive concepts will be set forth in the description which follows, and in part will be apparent from the description, or may be learned by practice of the inventive concepts.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 illustrates an exemplary network environment according to an exemplary embodiment of the invention.

FIG. 2 is a block diagram illustrating internal configuration of electronic device and server according to an exemplary embodiment.

FIG. 3 is a block diagram illustrating exemplary components that a processor of the server may include according to an exemplary embodiment.

FIG. 4 is a flow chart illustrating an exemplary method of providing intermediating service between user terminals to share vehicles according to an exemplary embodiment.

FIG. 5 is exemplary screens provided for describing operation available to vehicle provider and vehicle passenger with one ID according to an exemplary embodiment.

FIG. 6 is exemplary screens for providing matching result in accordance with intermediation request of terminal according to an exemplary embodiment.

FIG. 7 is a flow chart describing re-matching operation through modifying the time that the user leaves work when matching is failed according to an exemplary embodiment.

FIG. 8 is a flow chart describing operation providing remaining seat information of provider terminal in real-time according to an exemplary embodiment.

FIG. 9 is exemplary screens displayed on user terminal displaying remaining seat information updated in real-time according to an exemplary embodiment.

FIG. 10 is a flow chart describing an exemplary operation for setting a designated ride share members according to an exemplary embodiment.

FIG. 11 is a flow chart describing exemplary operation for providing reward for watching advertisement according to an exemplary embodiment.

### DETAILED DESCRIPTION

In the following description, for the purposes of explanation, numerous specific details are set forth in order to provide a thorough understanding of various exemplary embodiments or implementations of implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

The exemplary embodiments of the invention relate to a technology for intermediating vehicle providers and vehicle passengers to use vehicles, and particularly, a technology for matching the vehicle providers driving home by themselves with other users (i.e. vehicle passengers) that are leaving work at similar time travelling from similar departure point to similar destination, so that they may share their ride back home.

In the exemplary embodiments of the invention, ‘user terminals’ may refer to terminals that both users providing vehicles and users requesting vehicles. Particularly, user terminals may refer to terminals carried by vehicle passengers and provider terminals may refer to terminals carried by vehicle providers merely for description purpose. However, according to the exemplary embodiments of the invention, applications for vehicle providers and applications for vehicle passengers are not separately provided or installed on respective electronic devices such as a smartphone, and therefore, set-up information after subscribing with one ID and installing one application, users may use the same electronic devices to switch between the user terminals and provider terminals by inputted relevant set up information when executing the application.

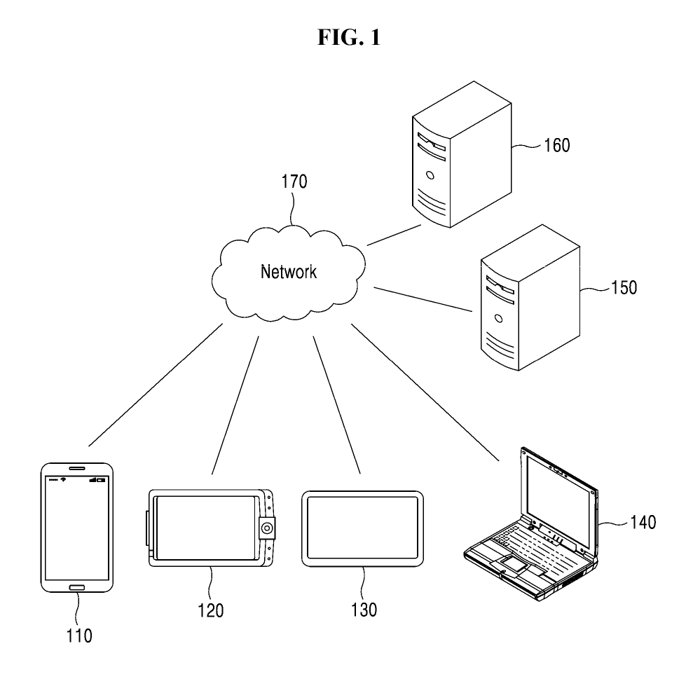

FIG. 1 illustrates an exemplary network environment according to an exemplary embodiment of the invention. The network environment of FIG. 1 indicates an example including a plurality of electronic devices 110 and 120, 130, and 140, a plurality of servers 150 and 160, and network 170. However, FIG. 1 is an example for describing the invention, and therefore, the exemplary embodiments are not necessarily limited to the number of electronic devices or the number of servers illustrated as FIG. 1.

The plurality of electronic devices 110 and 120, 130, and 140 may be fixed terminals implemented by a computer or portable terminals. Examples of the plurality of electronic devices 110 and 120, 130, and 140, may include a smart phone, a mobile phone, a navigation, a computer, a laptop, a digital broadcasting terminal, a PDA (Personal Digital Assistants), a PMP (Portable Multimedia Player), a tablet PC, and the like. For example, the first electronic device 110 may communicate with other electronic devices 120, 130, and 140 and/or the servers 150 and 160 through the network 170 using wireless or wired communication method.

The communication method is not limited and the network 170 may include a communication method utilizing communication network (e.g. mobile communication network, the wired Internet, the wireless Internet, and broadcasting network) as well as a short-range wireless communication. For example, the network 170 may include at least one of personal area network (PAN), local area network (LAN), campus area network (CAN), metropolitan area network (MAN), wide area network (WAN), broadband network (BBN), the Internet, and the like. Also, the network 170 may include at least one network topologies including bus network, star network, ring network, mesh network, star-bus network, tree or hierarchical network, and the like. However, the exemplary embodiments are not necessarily limited thereto.

Each of the servers 150 and 160 may be implemented with a computer device or a plurality of computer devices providing an instruction, a code, a file, content, a service, and the like by communicating through the plurality of electronic devices 110 and 120, 130, and 140 and the network 170.

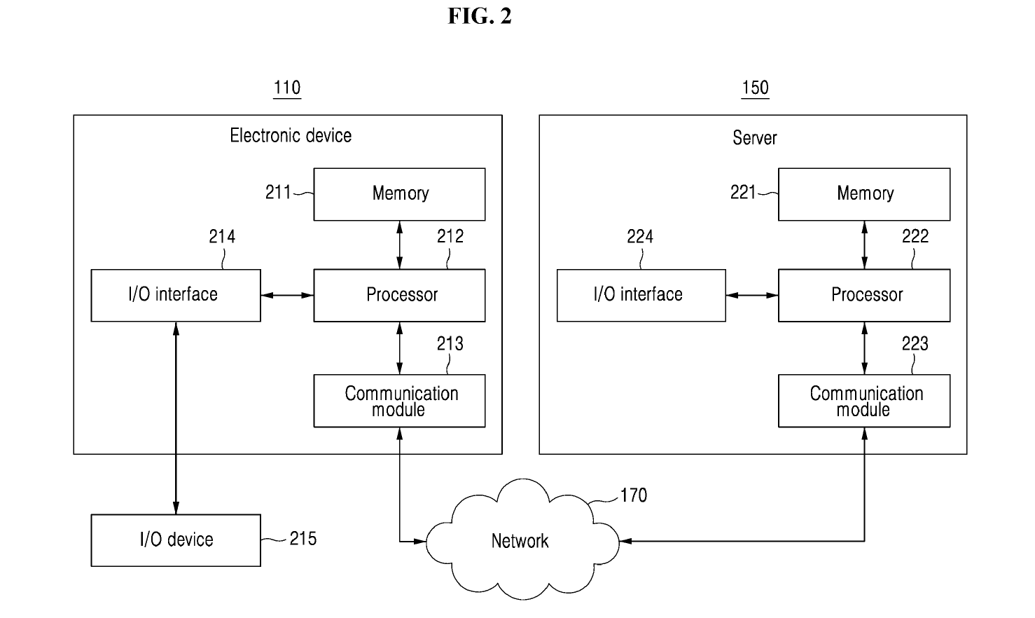

FIG. 2 is a block diagram illustrating internal configuration of electronic device and server according to an exemplary embodiment. FIG. 2 describes the internal configuration of the first electronic device 110 as an example of the electronic devices and the server 150 as an example of the servers. Other electronic devices 120, 130, and 140 and the server 160 may have same or similar internal configuration.

The first electronic device 110 and the server 150 may include memories 211 and 221, processors 212 and 222, communication modules 213 and 223, and input/output interfaces 214 and 224. The memories 211, 221 which are computer readable recording medium may include a permanent mass storage device such as RAM (random access memory), ROM (read only memory), and a disc drive. Also, the memories 211 and 221 may store OS (Operating System) or at least one program code (e.g. a code for the application installed and driven on the electronic device and the like). The software components may be loaded from other computer-readable recording medium separate from the memories 211 and 221. According to the exemplary embodiments, the software components may also be loaded to the memories 211 and 221 through the communication modules 213 and 223, not through the computer-readable recording medium. For example, at least one program may be loaded to the memories 211 and 221 based on a program (e.g. the described application) which is installed by files that developers or file distributing systems distributing application installation files (e.g. the described server 160) provide through the network 170.

The processors 212 and 222 may be configured to process instructions of computer program by performing basic arithmetic, logic, and input/output operation. The instructions may be provided to the processors 212 and 222 by the memories 211 and 221 or the communication modules 213 and 223. For example, the processors 212 and 222 may be configured to execute the instructions received in accordance with program code stored in the recording device such as the memories 211 and 221.

The communication modules 213 and 223 may provide a function for communicating the first electronic device 110 and the server 150 through the network 170 and provide a function for communicating with other electronic devices (e.g. a second electronic device 120) or other servers (e.g. the server 160). For example, a request that the processor 212 of the first electronic device 110 generates according to a program code stored in recording device such as the memory 211 may be transmitted to the server 150 through the network 170 according to control of the communication module 213. Conversely, a control signal or an instruction, content, a file, and the like which are provided according to control of the processor 222 of the server 150 may be received to the first electronic device 110 through the communication module 213 of the first electronic device 110 by going through the communication module 223 and the network 170. For example, the control signal or instruction, and the like of the server 150 received through the communication module 213 may be transmitted to the processor 212 or the memory 211, and content or file, and the like may be stored in the storage medium that the first electronic device 110 may further include.

The input/output interface 214 may be a means for interfacing with an input/output device 215. For example, an input device may include a keyboard, a mouse, etc., and an output device may include a device such as a display for displaying a communication session of an application. The input/output interface 214 may include an input function and an output function integrated into a single function such as a touch screen. As more specific example, when processing instructions of the computer program loaded to the memory 211, the processor 212 of the first electronic device 110 may display a service screen or content configured by using data provided by the server 150 or the second electronic device 120 on the display through the input/output interface 214.

According to the exemplary embodiments, the first electronic device 110 and the server 150 may include more components than the components of FIG. 2. However, there is no need to clearly illustrate most prior art components. For example, the first electronic device 110 may be implemented to include at least part of the described input/output device 215 or further include other components such as a transceiver, a GPS (Global Positioning System) module, a camera, various sensors, a database, and the like. As more specific example, when the first electronic device 110 is a smart phone, various components such as acceleration sensor or gyro sensor, camera, various physical buttons, button using touch panel, input/output port, vibrator for vibrating, and the like that the smart phone usually includes may be further included in the first electronic device 110.

Also, when database is included in the server 150, the database may match various information, for example, identifier information of the user terminal with member information inputted when subscribing, for providing vehicle sharing (i.e. service for sharing ride home) to several electronic devices (i.e. user terminals and vehicle providers) requesting vehicle sharing to the server 150, and may store and manage the matched information. Furthermore, the database may store and manage input information including such as identification information, time leaving work, destination, departure point, other conditions (e.g. age, gender, smoking preference, drinking preference, and the like), selection information (e.g. hobby, hometown, job, and the like) of the user terminals and identification information of matching provider terminals.

According to the exemplary embodiments, a system for intermediating user terminals to share vehicles may be implemented as a platform on a server intermediating devices where vehicle sharing application (App for sharing ride home) is run. In other words, according to the exemplary embodiments, a method of providing intermediating service between user terminals to share vehicles may be executed on all devices where the application is installed and executed. Hereinafter, for convenience of description, an exemplary embodiment will be described for performing a method of providing intermediating service between user terminals to share vehicles through a system for intermediating user terminals to share vehicles which is implemented in the server 150 according to intermediation request of the first electronic device 110 and the second electronic device 120 where a package file for installing and running application is stored.

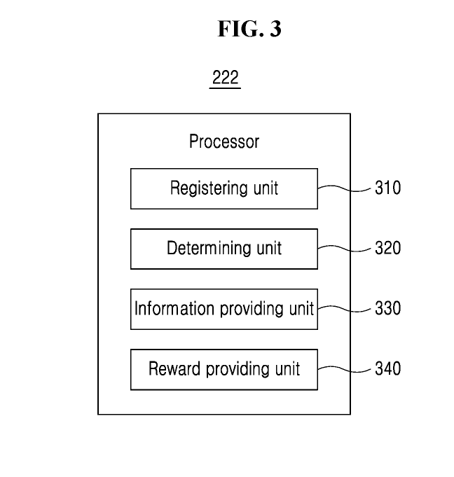

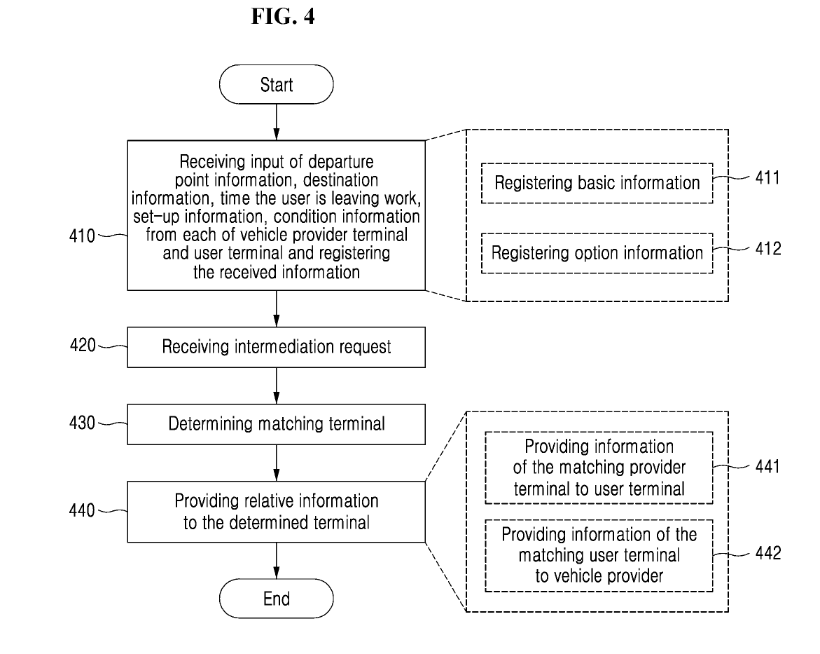

FIG. 3 is a block diagram illustrating exemplary components that a processor of the server may include according to an exemplary embodiment, and FIG. 4 is a flow chart illustrating an exemplary method of providing intermediating service between user terminals to share vehicles according to an exemplary embodiment.

The server 150 may implement the system for intermediating user terminals to share vehicles, and as illustrated in FIG. 3, by including the processor 222 in the server 150. The processor 222 may include a registering unit (or registering circuit) 310, a determining unit (or determining circuit) 320, an information providing unit (or information providing circuit) 330, and a reward providing unit (or reward providing circuit) 340 as components. Also, the processor 222 may identify each of electronic devices to search for terminals that matches the information that each of terminals receives for requesting intermediation, and may interwork with database which stores relevant information to corresponding electronic device. The processor 222 and the components of the processor 222 may control the server 150 to perform operations 410, 420, 430, and 440 included in the method of providing intermediating service between user terminals to share vehicles of FIG. 4. Here, the processor 222 and the components of the processor 222 may be implemented to execute instructions according to OS (Operating System) code and at least one program code included in the memory 221. Here, the components of the processor 222 may be functional representations of different functions and rules performed by the processor 222 according to control instruction provided by program code stored in the server 150. For example, in the method of providing intermediating service between user terminals to share vehicles according to the above described control instruction, the determining unit 320 may be a functional representation of the processor loading program code stored in a file for matching between users requesting vehicle sharing to the memory 221 to provide information related to the matched user terminal.

First, to provide intermediating service between the user terminals to share vehicles (i.e. sharing ride home) to the electronic devices 110 and 120 in the server 150, the program code stored in the file of program for the method of providing intermediating service between user terminals to share vehicles may be loaded to the memory 211 of the first electronic device 110 which is a user terminal such as a smart phone and the like. For example, when the program for the service intermediating user terminals to share vehicles (i.e. service sharing ride home) is executed on the first electronic device 110, the program code may be loaded to the memory 211 from the file of the program according to a control of OS.

Likewise, when the program for providing the intermediating service between user terminals to share vehicles is executed on the first electronic device 110, the first electronic device 110 may access a web page of the service intermediating user terminals to share vehicles provided by the server 150. Also, the first electronic device 110 may set set-up information indicating whether the first electronic device 110 is a provider terminal of a vehicle provider (i.e. vehicle driver) or a user terminal of a vehicle passenger (i.e., passenger), and when departure point, destination, time leaving work, condition information, and the like are received, the server 150 may search terminals matching the received information (e.g. electronic device 1, electronic device 2, and the like) requesting intermediation through the service app, and may perform the operations 410, 420, 430, and 440 to provide information relating to the searched matching terminals with other terminals.

Hereinafter, it is supposed and described that first electronic device 110 is a provider terminal of a vehicle provider and the second electronic device 120 is a user terminal of a vehicle passenger.

First, the registering unit 310 may install the service app on the provider terminal and the user terminal for sharing vehicles, receive subscription information when executing the app, and store and maintain the received information in the database. For example, initially received information may include phone number, ID, password, home address information, office address information, and the like of each of terminals, which may be stored and maintained in the database. Here, a phone number, an ID of the terminal, or a random number may be used as the identifier information of each of terminals. The subscription information, for example, ID and password may be used for certification of the corresponding terminal when the user terminal or provider terminal executes the service app and uses the service intermediating user terminals to share vehicles.

For example, the terminal executing the service app may receive ID and password, and if the received ID and password are identical with ID and password registered in the database and are successfully certified, the registering unit 310 may inform the certification success with the service app, and then, the service app may display a screen for receiving required information (e.g. set-up information, time leaving work, departure point, destination, condition information, and the like) for intermediating user terminals to share vehicles (i.e. the service sharing ride home) on the corresponding terminal.

In operation 410, the registering unit 310 may receive input of departure point information, destination information, the time leaving work, and condition information from each of provider terminal to share own vehicle with other users leaving work and user terminal to ride the vehicle through the service app installed on each of terminals, match the received information with identifier information of each of terminals, and store and maintain the matched information in the database.

In operation 411, when each of terminals wants to share vehicles at the time leaving work by executing the service app after subscribing, the registering unit 310 may receive basic information for sharing vehicles from the terminal (i.e. provider terminal or user terminal) executing the service app. Here, the basic information may include departure point information, destination information, the time leaving work, set-up information (i.e. information indicating whether it is a driver or a passenger), and condition information. The condition information may be preference information include age, gender, drinking preference, smoking preference, and the like.

For example, the preference information may represent the preference of the vehicle providers with the provider terminal with regard to a vehicle passenger or a user to share the vehicles with, including age, gender, drinking preference, smoking preference, and the like of the vehicle passenger. Also, the preference information may represent the preference of the vehicle passengers with the user terminals with regard to the vehicle provider to request a ride, including the age, gender, drinking preference, smoking preference, and the like.

In operation 412, when all basic information relating to intermediating user terminals to share vehicles is received, the registering unit 310 may receive option information from each of terminals. Here, the option information including hobby, job, hometown, and the like may be selectively received may not necessary to be inputted from each of the terminals. Accordingly, the registering unit 310 may receive the option information, but also may receive empty option information. Here, the registering unit 310 may receive the basic information and the option information described in operations 412 and 413 together from the service app, and may receive the option information with identifier information of each of terminals after receiving the basic information. Then, the registering unit 310 may match the received basic information and option information with identifier information of each of terminals and register and store the matched information in the database.

In operation 420, after all information for intermediating user terminals to share vehicles is registered, the determining unit 320 may receive intermediation request from the terminal. Here, if credit card information is registered in advance when subscribing, the card information doesn't need to separately be registered. If the card information is not registered when subscribing, the intermediation request may be normally performed after registering payment information such as credit card information or account transfer and the like. If there are reward points, payment with reward points may be used.

For example, when the provider terminal inputs basic information and option information and registers the information on the database, as the item of intermediation request display which is displayed on the screen of the provider terminal is selected, the determining unit 320 may receive the intermediation request with identifier information of the corresponding terminal from the provider terminal through the service app. Similarly, the determining unit 320 may receive intermediating request from the user terminal.

In operation 430, when the intermediation request is received, the determining unit 320 may determine (or search) at least one matching user terminal by referring to the database based on identifier information and the received basic information and option information of the terminal requesting intermediation. For example, when the provider terminal requests intermediation, the determining unit 320 may determine at least one to four user terminals matching with the basic information and option information received from the provider terminal. When the user terminal requests intermediation, the determining unit 320 may determine at least one provider terminal matching with the basic information and option information received from the user terminal.

In operation 440, the information providing unit 330 may provide information relating to the determined matching user terminal or the determined matching provider terminal to the terminal requesting intermediation.

As one example, in operation 441, when at least one matching user terminal is determined (or searched), the information providing unit 330 may provide the provider terminal requesting intermediation with information including phone number of the at least one determined matching user terminal, time and place to pick up the vehicle passenger corresponding with the determined user terminal, and the destination of the vehicle passenger corresponding with the determined user terminal.

As another example, in operation 442, when the provider terminal is determined (or searched), the information providing unit 330 may provide the user terminal requesting intermediation with information including phone number, vehicle number, and the destination of the vehicle provider of the provider terminal, and time and place to meet with the vehicle provider corresponding with the determined provider terminal.

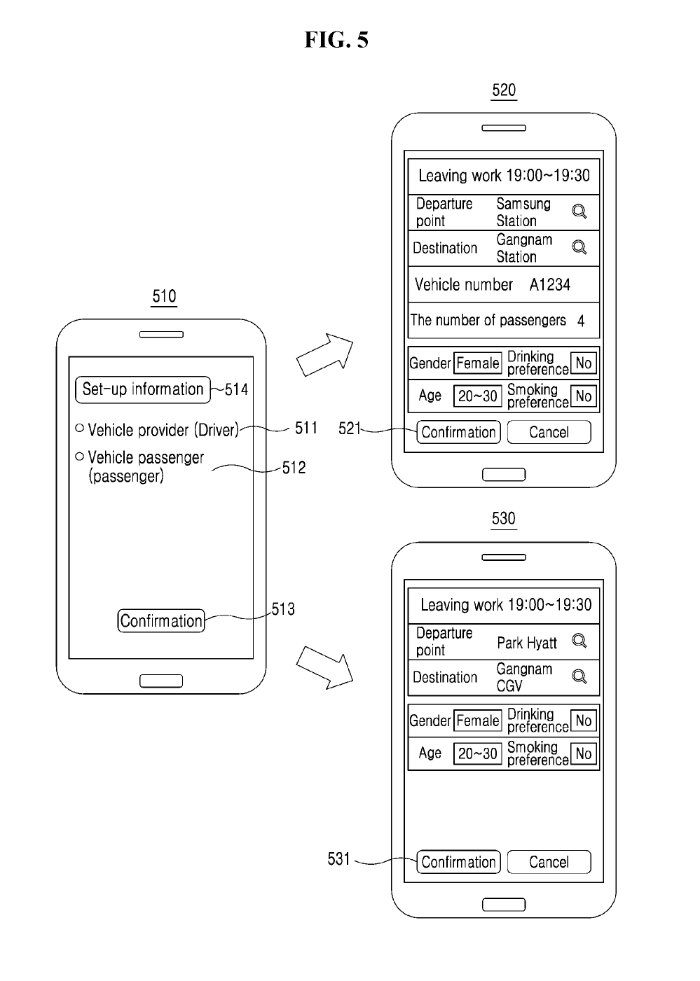

FIG. 5 is exemplary screens provided for describing operation available to vehicle provider and vehicle passenger with one ID according to an exemplary embodiment.

In other words, FIG. 5 illustrates exemplary screens displayed to receive basic information to screen of a certified terminal (provider terminal or user terminal) after inputting ID and password by executing service app.

Referring to FIG. 5, it is not that a service app for vehicle provider and a service app for vehicle passenger exist separately, but that one common service application may exist for intermediating user terminal to share vehicles. Accordingly, when the service app is installed on a provider terminal or a user terminal (i.e., vehicle passenger) and executed, input of set-up information may be received to confirm whether the corresponding terminal provides a vehicle or rides a vehicle, and the registering unit 310 may receive the inputted set-up information from the terminal through the service app.

For example, according to screen 510, whether the corresponding terminal is a vehicle provider 511 or a vehicle passenger 512 may be selected by a user.

For example, after display information corresponding to the vehicle provider 511 is selected, when a display information 513 corresponding to confirmation is selected, the registering unit 310 may receive set-up information 514 which is set as the vehicle provider with identifier information of the corresponding terminal from the corresponding terminal, and may match and store the set-up information which is set as the vehicle provider with the identifier information of the corresponding terminal in the database. Here, the set-up information may be modified whenever the terminal changes the set-up information. In other words, when the terminal changes the set-up information to a user terminal, the set-up information matched with the identifier information of the corresponding terminal in the database may be modified from the vehicle provider to the user terminal.

Likewise, when the set-up information 514 is set as the vehicle provider, screen 520 of the terminal may be displayed a screen for receiving input of basic information corresponding to the vehicle provider. For example, the screen may be displayed to receive input of information relating to the vehicle provider, oneself, such as the time leaving work, departure point, destination, vehicle number, the number of passengers, and the like and information relating to passengers to ride the vehicle such as gender, drinking preference, age, smoking preference, and the like. Besides, an item for receiving input of price for sharing vehicles from departure point to destination may be separately displayed on the screen 520. Also, after all information displayed on the screen 520 is inputted, when display information 521 corresponding to confirmation is selected, the registering unit 310 may receive identifier information of the provider terminal with basic information (i.e., the time leaving work, departure point, destination, vehicle number, the number of passengers, gender, drinking preference, age, smoking preference) of the vehicle provider. Then, the registering unit 310 may search terminals corresponding to the received identifier information among terminals stored in the database, match the received basic information with identifier information of the searched terminals, and register and manage the matched information.

As another example, after display information corresponding to the user terminal 512 is selected, when display information 513 corresponding to confirmation is selected, the registering unit 310 may receive the set-up information 514 which is set as the user terminal with identifier information of the corresponding terminal from the corresponding terminal, match the set-up information 514 which is set as the user terminal with the identifier information of the corresponding terminal and store the matched information in the database. Then, a screen for receiving input of basic information corresponding to the user terminal (i.e., vehicle passenger) may be displayed on the screen 530 of the terminal. For example, the screen 530 may be displayed to receive input of information relating to the vehicle passenger, oneself, such as time leaving work, departure point, destination, and the like of the vehicle passenger and information relating to the provider of a vehicle that the user, oneself, will ride such as gender, drinking preference, age, smoking preference, and the like. Also, after all information displayed on the screen 530 is inputted, when display information 531 corresponding to confirmation is selected, the registering unit 310 may receive identifier information of the user terminal with basic information (i.e., time leaving work, departure point, destination, gender, drinking preference, age, smoking preference) of the user terminal. Then, the registering unit 310 may search terminals corresponding to the received identifier information among terminals stored in the database, match the received basic information with the identifier information of the searched terminal, and register and maintain the matched information.

Also, after all basic information is inputted, the screen of the terminal may be changed to a screen for receiving input of option information, and besides, a screen may be configured to input option information on the bottom of the basic information. For example, an item to receive input of hobby, job, hometown, and the like as option information may be displayed on the bottom of items of age and smoking preference displayed on the screens 520, 530.

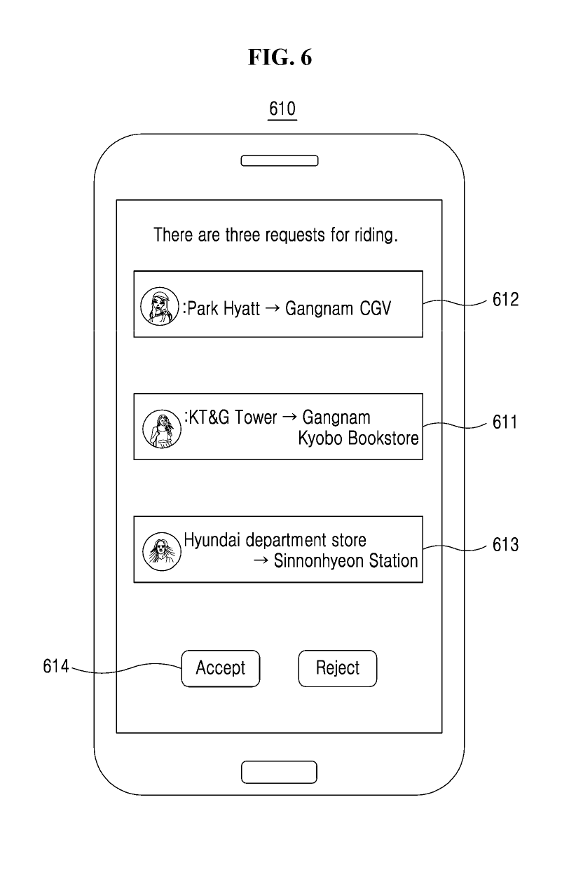

FIG. 6 is exemplary screens for providing matching result in accordance with intermediation request of terminal according to an exemplary embodiment.

In FIG. 6, a screen 610 may indicate an exemplary screen displayed on a screen of a provider terminal when set-up information is a vehicle provider, and a screen 620 may indicate an example of screen which is displayed on a screen of a user terminal when set-up information is a user terminal.

Referring to the screen 610, the determining unit 320 have determined and searched that three user terminals (i.e., users) as the vehicle passengers that match the basic information of the vehicle provider requesting intermediating service to share the vehicle by referring to the database. For example, the basic information received with the request may specify that: the time that the vehicle provider is leaving work to request the ride share is “from 19:00 to 19:30”, departure point is “Samsung Station”, destination is “Gangnam Station”, gender is “female”, age is “twenty to thirties”, smoking preference is “no”, drinking preference is “no”, which are received from the providing terminal of the vehicle provider. Then, the information providing unit 330 may provide information corresponding to each of matching three user terminals 611, 612, and 612 that is matched with the provider terminal. For example, the information providing unit 330 may provide departure point and destination information received from the first user terminal, departure point and destination information received from the second user terminal, and departure point and destination information received from the third user terminal to the provider terminal.

Then, the screen 610 may be displayed on the screen of the provider terminal running the service app. Here, the vehicle provider may accept all three of the matching user terminals of the vehicle passengers by selecting the accept 614 button displayed on the provider terminal. The vehicle provider may also selectively accept some of the three matching user terminals of the vehicle passengers by selecting user terminals and selecting the accept 614 button.

Then, the determining unit 320 may receive identifier information of the accepted user terminals and identifier information of the vehicle provider from the provider terminal. Then, the information providing unit 330 may request for acceptance of the provider terminal of the vehicle provider to each user terminals selected by the vehicle provider based on the identifier information of the selected user terminals through the service app. Accordingly, acceptance and rejection of the service may be exchanged in both directions. Here, when all of three user terminals accept the selection made by the vehicle provider, the determining unit 320 may receive identifier information of the corresponding user terminal and identifier information of the accepted provider terminal from each of user terminals, match the identifier information of the user terminals with the provider terminal based on each identifier information, and store and maintain the matching result in the database.

When acceptance of service is exchanged both direction between the matched provider terminals and user terminals, the determining unit 320 may determine the time, order, and location of pick up, destinations and estimated time of arrival (ETA) of each of the user terminals of the vehicle passengers, based on the basic information received from the vehicle provider and the accepted user terminals.

For example, when all of the first, second, and third user terminals are accepted, the pick up order may be determined in order of the first user terminal (KT&G Tower), the second user terminal (Park Hyatt), and the third user terminal (Hyundai department store) which correspond to the order of proximity from the departure point of the vehicle provider. Here, when it is difficult to turn left or make a U-turn because of road situation or when the vehicle passengers (i.e., passengers) are positioned within predefined distance or time or corresponds to no parking and stopping zone, the determining unit 320 may combine the pick up locations of the vehicle passengers. For example, if the second user terminal is located at a right turn corner of the road and the vehicle provider needs to make a left turn to the third user terminal at Park Hyatt, the determining unit 320 may determine that it is difficult to pick up the second user terminal on the way to pick up the third user terminal, and combine the pick up location of the second user terminal with the pick up location of the first user terminal, which is KT&G Tower.

Then, the information providing unit 330 may provide the time, order, and location of pick up of each of the user terminals and information of the user terminals (e.g., phone number information of user terminals) to the provider terminal. Here, the information providing unit 330 may mark and provide the pick up location of each of the user terminals from the departure point of the vehicle provider on a map in connection with the map to the vehicle provider. Also, the information providing unit 330 may provide information of the vehicle provider (e.g., phone number, vehicle number, and the like of the vehicle provider) to each of the first, second, and third user terminals, and provide the time, order, and location of pick up of each of the user terminals. Here, the information providing unit 330 may mark and provide routes from departure points of each of the user terminals to the determined pick up locations on a map in connection with the map to each of the user terminals.

Likewise, when the provider terminal is guided to the pick up location and the provider terminal and the user terminals start to share the vehicle, i.e., the vehicle passengers of the user terminals gets in the vehicle of the vehicle provider of the provider terminal, a location tracking unit included in the system for intermediating user terminals to share vehicles in the server 150 may receive a normal ride share indicator representing a normal ride share from the both terminals. Upon receiving the normal ride share indicator, the location tracking unit may track location of each of terminals. For example, the location tracking unit may perform location tracking until a service completion indicator representing the completion of ride share service is received after the user terminals get off at the corresponding destination. Here, the location tracking unit may receive the service completion indicator in both directions, i.e., from both of the provider terminal and the user terminals, and may end the location tracking by receiving all of them. For example, after the first user terminal gets off the shared vehicle at the first destination, the first vehicle passenger of the first user terminal may select “ride share complete” button displayed on a screen provided through the service app and the vehicle provider of the provider terminal may also select “ride share complete” button displayed on the first user terminal, and the location tracking may be ended.

When the first vehicle passenger of the first user terminal selects the “ride share complete” button displayed on the first user terminal, a payment processing unit may process the payment (e.g., 3000 Korean won) by communicating with corresponding credit card server based on credit card information registered in the first user terminal. After the payment is completed, an indicator notifying a successful transaction may be provided to the first user terminal. Here, the processor 222 may further include the payment processing unit for the payment process.

Also, after completion of the ride share service and the payment, the processor 222 may further include an evaluation processing unit for evaluating satisfaction of the service. For example, the provider terminal may request for the level of satisfaction of the vehicle passengers of the user terminals, and the user terminals may request for the level of satisfaction of the vehicle provider of the provider terminal. Also, link information (e.g., URL) to preconfigured questionnaires may be provided to the vehicle provider and the vehicle passengers asking whether the vehicle provider or the vehicle passengers should be allowed to use the service. In addition, after confirming the result of questionnaires, it may be used to determine whether to match the vehicle provider and the vehicle passengers as designated ride share members.

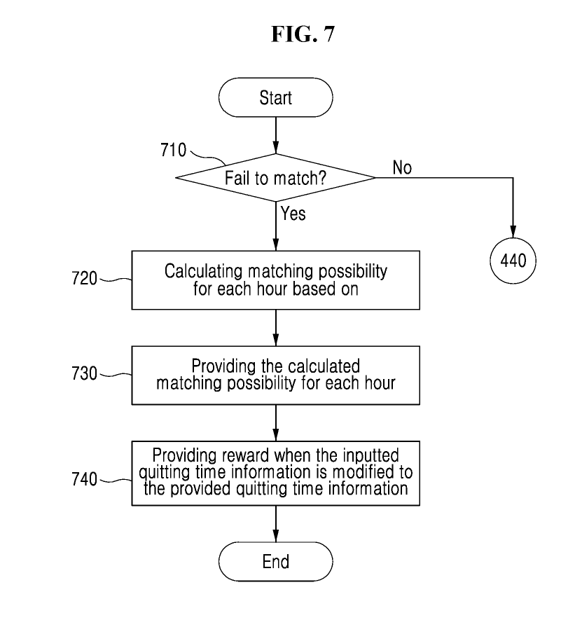

FIG. 7 is a flow chart describing re-matching operation through modifying the time leaving work when matching fails according to an exemplary embodiment.

Each of operations 710, 720, 730, and 740 of FIG. 7 may be performed by the registering unit 310, the determining unit 320, the information providing unit 330, and the reward providing unit 340.

In FIG. 7, matching failure on the provider terminal may occur when the system fails to find any user terminal that matches with essential basic information received from the provider terminal. The essential basic information includes the time leaving work, departure point, and destination information, which are essential information among basic information. Matching failure on the user terminal may occur when the system fails to find any provider terminal that matches with essential basic information received from the user terminal. The essential basic information includes the time leaving work, departure point, and destination information, which are essential information among basic information. Here, since the case of successful matching is already described above regarding operations 430 and 440 of FIG. 4, duplicated description will be omitted.

Regarding FIG. 7, a case of matching failure in the provider terminal will be described as an example; however, the exemplary embodiments are not limited thereto, and substantially the same process may be applied in case of matching failure in the user terminal.

In case of the matching fails in operation 710 the determining unit 320 may calculate matching possibility with other user terminals that has registered the time leaving work near or around the time that the vehicle provider is requesting the ride share received from the provider terminal.

For example, in case the matching failed for time slot between 19:00 and 19:30 as the time that the vehicle provider leaves work to request the ride share originally received from the provider terminal, the determining unit 320 may calculate the matching possibility (i.e., probability) for time slots every 10 minutes, 20 minutes, or 30 minutes within 1 hour before and after between 19:00 and 19:30. For example, when calculating every 30 minutes, the determining unit 320 may calculate that matching possibility for a time slot between 18:00 and 18:30 to be 10%, matching possibility for a time slot between 18:30 and 19:00 to be 80%, matching possibility for a time slot between 19:30 and 20:00 to be 90%, and matching possibility for a time slot between 20:00 and 20:30 to be 50%.

In operation 730, the information providing unit 330 may provide the matching possibility information calculated for different time slots to the provider terminal through the service app. In other words, the matching possibility information for the different time slots (e.g. matching percentage for each time slots) may be displayed on a screen of the provider terminal.

In operation 740, when the time the user is leaving work of the provider terminal is modified based on the matching possibility for the time slots provided by the information provider unit 330, the determining unit 320 may receive the modified time leaving work from the provider terminal. Also, the reward providing unit 340 may provide a reward for modifying the time the user is leaving work to request the ride share of the provider terminal to the provider terminal.

For example, when any one time slot among the different time slot with the matching possibility displayed on the screen of the provider terminal of the vehicle provider is selected, the determining unit 320 may modify the time leaving work from the original time leaving work between 19:00 and 19:30 to the selected time slot. For example, the vehicle provider may adjust the time leaving work to between 18:30 and 19:00, which may not have the highest matching possibility, the determining unit 320 may modify the time leaving work of the provider terminal matched to the identifier information of the provider terminal in the database from between 19:00 and 19:30 to between 18:30 and 19:00. Then, the determining unit 320 may search for user terminals matching to the modified time the user requesting ride share (18:30 to 19:00), departure point, destination, and condition information in the database and provide the searched user terminals to the provider terminal. when the provider terminal accepts all or some of the searched user terminal, the accepted user terminals may accept the riding sharing from the provider terminal in both directions. Here, when the request to share a ride from the user terminals matched to the modified time that the vehicle provider is leaving work are accepted in both directions and the vehicle is shared, the reward providing unit 340 may provide a reward to the provider terminal for modifying the time the user is requesting the ride share because the vehicle provider may be leaving the work to share the ride when it may not be the most convenient time for the vehicle provider to leave the work. For example, the reward providing unit 340 may provide predefined reward points, free gas coupon, vehicle maintenance coupon, and the like to the vehicle provider of the provider terminal.

Similarly, when the user terminals fail to match, the determining unit 320 may calculate matching possibility between the user terminals and the provider terminals to share a vehicle for other time slots and the calculated matching possibility for each of the other time slots may be displayed on the screen of the user terminal. Also, when the user terminal succeeds in matching by modifying the time the vehicle passenger is leaving work, the reward providing unit 340 may provide a reward for modifying the time the user is leaving work to the user terminal. For example, the reward providing unit 340 may provide discount coupon for using vehicle sharing service (e.g., 10% discount or 1,000 Korean won discount) and the like to the user terminal.

Also, referring to the operation 730, the determining unit 320 may provide the matching possibility for each hour to the provider terminal. However, the exemplary embodiments are not limited thereto, and the determining unit 320 may provide a message “Vehicle matching failed. Would you like to modify the time you are leaving work?” to the vehicle provider/the user terminals through the service app. Also, when the user selects time modification to modify the time leaving office, the determining unit 320 may determine user terminals/provider terminal matching to a different time slot closest to the time the user is leaving work originally received from the user terminals/the provider terminal by referring to the database. Also, information relating to the selected terminals (e.g., the screen 610 of FIG. 6) may be provided to corresponding terminals. When time modification is selected, the determining unit 320 may also determine the user terminals/the provider terminal matching for the time slot with the highest matching probability, e.g. between 20:00 and 20:30 with 90% of matching probability, by referring to the database, and provide information relating to the determined terminal to the provider terminal/user terminals. Here, when time modification is selected to modify the time that the user is leaving work, but the time the user should leave work for the matched user terminals/provider terminal is unacceptable to the user, the user may refuse to accept the vehicle matching result.

Accordingly, in case the vehicle matching ultimately fails due to a vehicle provider's refusal, the vehicle provider may decide not to share the ride; however, in case the vehicle matching ultimately fails due to a vehicle passenger's refusal, the system for intermediating user terminals to share vehicles may suggest an alternative route home to the user terminals by accommodating available taxis or off-duty vehicles. In other words, when vehicle matching finally fails, the determining unit 320 may check whether the corresponding terminal is a provider terminal or a user terminal based on set-up information of the failed terminal. When the terminal which finally failed to match is a user terminal, additional information regarding currently available taxis, a off-duty vehicles (e.g. church bus, kindergarten bus, daycare center bus, and the like), or a call-bus service may be provided to the user terminal.

For example, the determining unit 320 may provide the received departure point information, destination information, time the user is leaving work of the user terminal to a taxi company's server or off-duty vehicle company's server or call-bus server, and the like, and receive available vehicle number, riding point, phone number of taxi/dormant vehicle from the taxi company/the dormant vehicle company based on the provided information from the user terminal. Then, the determining unit 320 may provide the received information (i.e., vehicle number, riding point, phone number of taxi/dormant vehicle) of the available service to the user terminal.

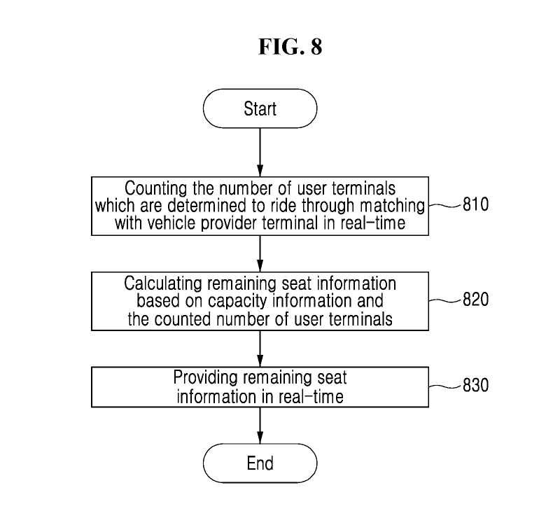

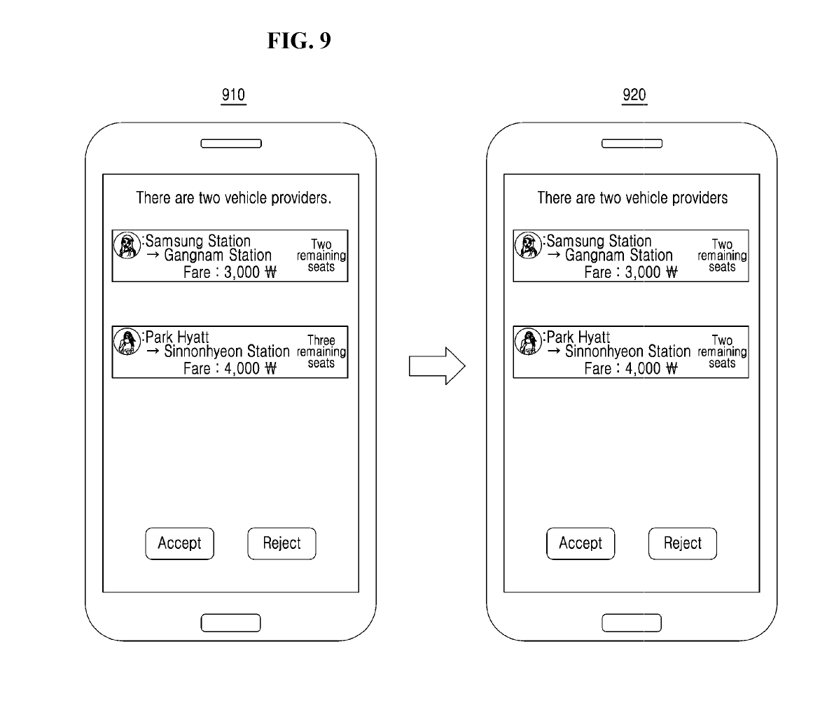

FIG. 8 is a flow chart describing operation providing remaining seat information of provider terminal in real-time according to an exemplary embodiment, and FIG. 9 is exemplary screens displayed on user terminal displaying remaining seat information updated in real-time according to an exemplary embodiment.

Referring to FIG. 8, in operation 810, the determining unit 320 may count the number of user terminals which are determined to ride from both ends (i.e., accepting vehicle sharing in both directions) through matching with provider terminal in real-time.

For example, when there are matching user terminals and the provider terminal, and the vehicle provider and the vehicle passengers accepts to share the vehicle from both ends, the determining unit 320 may receive identifier information of the corresponding terminals and identifier information of the corresponding provider terminal/user terminals along with an indicator indicating that the provider terminal and user terminals have accepted the ride share. The determining unit 320 may count the number of terminals that have accepted the ride share from both ends based on the identifier information of the corresponding provider terminal and the user terminals, and the indicators. Here, when there are three user terminals and one provider terminal matched and all of the matched three user terminals and the provider terminal accepts the matching result to share the ride, the determining unit 320 may count the number of the user terminals relating to the provider terminal as three based on the indicator, the identifier information of the provider terminal, and the identifier information of the user terminals.

In operation 820, the determining unit 320 may calculate number of remaining seats based on the vehicle capacity of the shared vehicle of the provider terminal and the number of the accepted user terminals.

For example, if vehicle capacity is received and registered in the database as four seats when requesting intermediation, the determining unit 320 may calculate remaining seat information as one by subtracting three, which is the number of user terminals sharing the ride from four, which is the vehicle capacity. Also, the determining unit 320 may apply the remaining seat information to future matching.

In operation 830, the information providing unit 330 may provide the calculated remaining seat information to at least one user terminal matching with the vehicle provider.

For example, referring to FIG. 9, a screen 910 may indicate a screen including information relating to the provider terminal matched with the user terminal after requesting intermediation. Here, when it is displayed that remaining seat of a first provider terminal which is matched with user terminal is two and remaining seat of a matched second provider terminal is three, but the second provider terminal is accepted in both directions by another user terminal, the remaining seat in the shared vehicle of the second vehicle provider may be updated in a real-time based on the remaining seat information received through the service app from the system for intermediating user terminal to share vehicles. In other words, in the screen 910 of the user terminal, the three remaining seats of the second provider terminal may be updated as the two remaining seats in a real-time, referring to a screen 920. On the contrary, when someone cancels to ride and the number of the remaining seat is changed, the remaining seat may be updated from three to four or from two to three in a real-time.

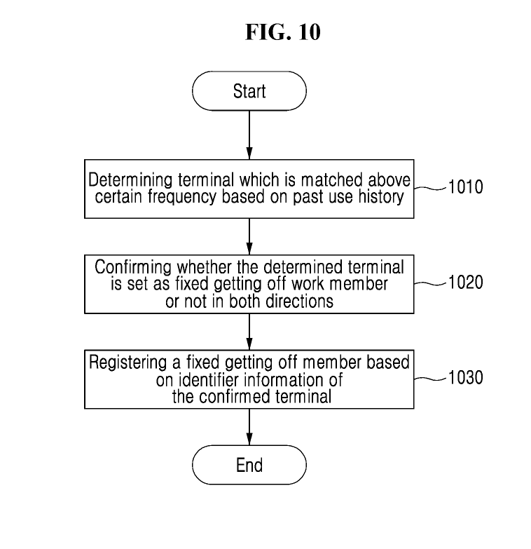

FIG. 10 is a flow chart describing an exemplary operation for setting a designated ride share members according to an exemplary embodiment.

Referring to FIG. 10, the described operation may set a designated ride share members that routinely share the ride by asking whether the vehicle provider of the provider terminal and the vehicle passenger of the user terminals that have been matched several times to share ride home would want to routinely share the ride with the matches users through the service app.

Referring to operation 1010, the determining unit 320 may refer to the past use history of each of terminals which are registered and maintained in the database to determine the terminals that had actually been successfully matched for over a certain predefined frequency. In other words, a terminal pair, i.e., provider terminal-user terminal, that has shared ride home over a certain frequency may be determined. Here, In FIG. 10, an exemplary embodiment which determines that the terminal pair includes one provider terminal and one user terminal is described as an example; however, exemplary embodiments are not limited thereto, and any number of user terminals may be determined as a nominee for the designated ride share members as the number of riding capacity that the provider terminal sets as a designated ride share members. For example, four user terminals relating provider terminal may be determined based on the past use history.

For example, when there is a record that a first provider terminal and a first user terminal shared ride home equal to or more than three times, the determining unit 320 may determine the first provider terminal and the first user terminal that had shared the ride together equal to or more than three times as nominee for the designated ride share members.

The determining unit 320 may also use evaluation result to determine the designated ride share members. For example, when the number of potential nominees for the designated ride share members is greater than the vehicle capacity, the nominee may be determined in the order of the evaluation result. Also, the determining unit 320 may exclude a terminal from determining as a nominee for the designated ride share members of the corresponding terminal when the terminal received an evaluation result below a predefined reference value or the user selected never to share the ride again (e.g. excluding from matching in the future).

In operation 1020, the information providing unit 330 may confirm in both directions whether the determined terminal sets as a designated ride share members.

In operation 1030, the determining unit 320 may register the designated ride share members based on identifier information of the confirmed terminal.

For example, the information providing unit 330 may provide information relating to the first user terminal (e.g. nickname, profile information, and previous history of leaving work, and the like) with a code indicator for instruction asking whether to set the first user terminal as a designated ride share members to the provider terminal 1. Then, a message asking whether to set the first user terminal as a designated ride share members may be displayed on a screen of the first user terminal through the service app installed on the provider terminal 1. For example, when the provider terminal runs the service app, a message of “Would you like to set the first user terminal as a designated ride share members?” may be displayed with information of nickname of the first user terminal, sharing ride home from Place A to Place B three times (10/2, 10/5, 10/7), and the like. Similarly, when the first user terminal runs the service app, a message of “Would you like to set the first provider terminal as a designated ride share members?” may be displayed with information of nickname of the provider terminal 1, sharing ride home from Place A to Place B at time the user is leaving work 19:00 to 19:30 three times (10/2, 10/5, 10/7), and the like.

Here, when all of both sides of the vehicle provider and the vehicle passenger accept the proposed designated ride share members, the determining unit 320 may receive identifier information of each of terminals with an indicator indicating acceptance, match the received identifier information of the provider terminal, identifier information of the user terminals, and the designated ride share members indicator, and store and maintain the matched information in the database. Also, the determining unit 320 may register, maintain, and manage the first provider terminal and the first user terminal as a designated ride share members in the database by matching the time the user is leaving work using on 10/2, 10/5, 10/7 which is a previous record, departure point Place A, destination Place B with the designated ride share members indicator, identifier information of each of terminals and storing the matched information.

Likewise, when the designated ride share members is registered, the information providing unit 330 may request to confirm whether there is any changes to the condition of leaving work to the first provider terminal and the first user terminal every day at predefined time based on the registered time the user is leaving work. For example, on every morning, every lunch time or before a predefined time (e.g., two hours before) from the registered time the user is leaving work, the information providing unit 330 may request to confirm whether the first vehicle provider and the first vehicle passenger will be leaving work from Place A to Place B at today time the user is leaving work (19:00 to 19:30) to the first provider terminal and the first user terminal through the service app. Here, when an indicator indicating routine schedule to leave office is received as display information of “routine schedule to leave office” is selected from both directions (i.e., the first provider terminal and the first user terminal), the information providing unit 330 may transmit a code indicator indicating a message to display the message such as “there is no change to today's ride share schedule. The first user terminal/the provider terminal is ok to leave the office between 19:00 and 19:30!” on each of terminals to the first user terminal and the first provider terminal through the service app. Then, the message may be displayed on each of terminals.

Here, rather than “routine schedule to leave office,” when an indicator indicating “unable to leave the work as scheduled” is received from any one of the first provider terminal and the first user terminal, the information providing unit 330 may provide an indicator for providing a message such as “Today the first user terminal/the first provider terminal may not leave the office as scheduled. Would you like to match up with other users?” to the terminal that notified to leave work on as scheduled. Here, when the corresponding terminal selects to match up with other users, the determining unit 320 may search for other provider terminals/user terminals in the database and provide to the corresponding matching result.

Meanwhile, the past use history data of each of users recorded in the database which is described in FIG. 10 may be used as statistical data for understanding regional traffic congestion, traffic flow on rush hour, and the like.

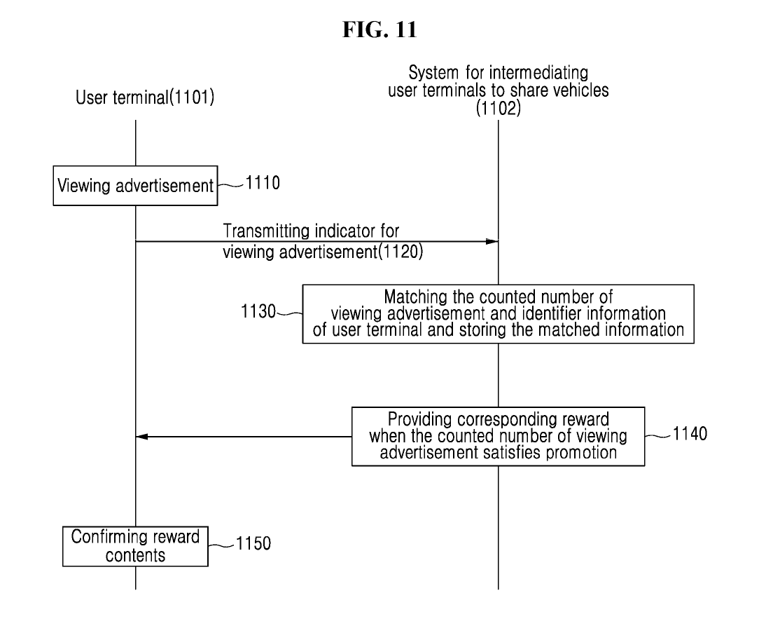

FIG. 11 is a flow chart describing exemplary operation for providing reward for watching advertisement according to an exemplary embodiment.

Referring to FIG. 11, in operation 1110, a first user terminal 101 may view advertisements.

For example, when a service app for sharing vehicles is executed, an advertisement (e.g., advertisement relating to vehicles, vehicle products advertisement such as air freshener, and the like) may be automatically played. For example, when a user having the user terminal 1101 runs the service app, advertisement may be played on a screen of the user terminal 1101 by selecting (e.g., click, touch, and the like) display information for viewing advertisement which is displayed on the top or bottom of the screen for applying free or discount coupon. Here, types of coupons may be different depending on advertisements. For example, 10 seconds advertisement may match to 10% discount coupon, 20 seconds advertisement may match to 20% discount coupon, and one minute advertisement may match to one time free pass.

When it is completed to view advertisement which is played on the user terminal 1101, in operation 1120, the reward providing unit 340 may receive identifier of the advertisement which is completed to be viewed and an indicator indicating completion of viewing of the advertisement. Here, the user terminal 1101 may transmit identifier information of the user terminal 1101 with the identifier information and indicator to a system for intermediating user terminals to share vehicles 1102.

In operation 1130, the reward providing unit 340 may count the number of advertisements viewed which are matched to a corresponding terminal based on the received identifier information of advertisement, indicator, and identifier information of the user terminal 1101. For example, when the number of viewing advertisements before is four, the number of viewing advertisements may be counted as five through receiving the indicator. Also, the reward providing unit 340 may match and store the counted number of viewing advertisements (five times) and the identifier information of the user terminal 1101. In other words, the reward providing unit 340 may update the number of viewing advertisements of the user terminal 1101 stored in the database as the counted number of viewing advertisements.

In operation 1140, when the counted number of viewing advertisements satisfies promotion, the reward providing unit 340 may provide a reward corresponding to the promotion to the user terminal 1101. Here, for providing a reward corresponding to the promotion, promotion policy for each of advertisements may be stored and maintained in advance in the database.

For example, when the number of viewing advertisements is five, a promotion of 10% discount is ongoing, and when the number of viewing of advertisements is 10, a promotion of one time free is ongoing. When the counted number of viewing advertisements of the user terminal 1101 corresponds to five, the reward providing unit 340 may match and store an indicator indicating a 10% coupon with the identifier information of the user terminal 1101. Besides, when the number of viewing advertisements is one, but the indicator relating advertisements corresponds to one time free, the reward providing unit 340 may match and store an indicator indicating one time free to the identifier information of the user terminal 1101 in case of matching to the coupon. Also, the reward providing unit 340 may provide reward information including 10% discount coupon or one time free coupon to the user terminal 1101.

In operation 1150, the user terminal 1101 may confirm reward contents (e.g., 10% discount coupon, one time free coupon) based on the reward information provided from the system for mediating user terminal to share vehicles 1102.

For example, after viewing of advertisement is completed, when the corresponding advertisement corresponds to five times viewing, a message of “a 10% discount coupon is issued” may be displayed on a screen of the user terminal 1101.

As described above, the method and system for intermediating user terminals to share vehicles according to the exemplary embodiments, many users may provide to share vehicles to leave work and go home through the service app after work and individually and autonomously adjust the time they leave work. Also, even the system fails to match the users to share a vehicle after work, the method and system for intermediating user terminals to share vehicles according to the exemplary embodiments may request that the vehicle passenger or vehicle provider to modify time they leave work to successfully match vehicle share, and may provide a reward when the request is accepted, increasing the efficiency and the efficacy of the method and system so that it may lead more users to successfully share the ride home and promote more people to share the ride home.

Also, the user may select a set-up information indicating whether the user is a vehicle provider or vehicle passenger using the same service application, rather than using different service applications. Therefore, vehicle sharing service may be provided with the same service application and identification, i.e., one ID.

In the exemplary embodiments, the elements and components including, Memory 211 and 221, Processor 212 and 222, Communication module 213 and 223, I/O interface 214 and 224, I/O device 215, and/or one or more components there of described herein may be implemented using hardware components, software components, and/or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method of providing intermediating service between terminals comprising at least one provider terminal of a vehicle provider and at least one user terminal of a vehicle passenger to share vehicles executed by a computer, the method comprising:
receiving departure point information, destination information, a time the vehicle provider is leaving work, set-up information, and condition information from terminals, matching and registering the received information with identifier information of the at least one provider terminal and the at least one user terminal;
receiving intermediation request from the terminals;
determining at least one user terminal and at least one provider terminal among the terminals matching each other based on the registered departure point information, the destination information, the time the user is leaving work, the set-up information, and the condition information of the terminals that transmitted the intermediation request;
providing information of the matched at least one user terminal to the matched at least one provider terminal; and
providing information of the matched at least one provider terminal to the matched at least one user terminal.

2. The method of claim 1, wherein the determining comprises:
calculating matching possibility for time slots apart from the time the user is leaving work of the user terminal and the provider terminal for every predefined time unit, in response to failing to match at least one user terminal and at least one provider terminal; and
providing the calculated matching possibility for each time slots to the user terminal and the provider terminal.

3. The method of claim 2, further comprising: providing a reward for modifying time the user is leaving work in response to the at least one user terminal and the at least one provider terminal modifying the time the user is leaving work based on the received matching possibility for each time slot.

4. The method of claim 1, wherein the terminals are determined to be one of a provider terminal of a vehicle provider or a user terminal of a vehicle passenger in response to the corresponding set-up information.

5. The method of claim 1, wherein the determining comprises matching at least one provider terminal and at least one user terminal which have closest matching time the user is leaving work in response to failing to match at least one user terminal and at least one provider terminal.

6. The method of claim 1, further comprising:
providing information regarding alternative route home in response to failing to match at least one user terminal and at least one vehicle provider, comprising providing information relating to available taxis and off-duty vehicles service determined based on the departure point information, destination information, and time the user is leaving work of the user terminal.

7. The method of claim 1, wherein the determining comprises:
determining pick up location and destination of the at least one user terminal based on the departure point information and destination information of the user terminal and relevant traffic regulations, and
providing the determined pick up location and destination of the at least one user terminal to the at least one user terminal and the at least one provider terminal.

8. The method of claim 1, further comprising:
counting the number of view of provided advertisement in the user terminal; and
determining whether to provide a reward comprising riding discount coupon and free riding coupon, based on the counted number of view of advertisement.

9. The method of claim 1, wherein the determining comprises calculating remaining seat information, comprising:
counting the number of at least one user terminal determined to ride the vehicle through matching with the at least one provider terminal, and
calculating remaining seat information based on vehicle capacity information received from the at least one provider terminal and the counted number of user terminal, and
the providing the calculated remaining seat information of the matched at least one provider terminal to the matched at least one user terminal.

10. The method of claim 1, the determining comprises:
determining terminals that had been successfully matched equal to or greater than a predefined certain frequency based on the past use history of the at least one provider terminal and the at least one user terminal; and
registering the determined terminal as designated ride share members by confirming whether the users of the determined terminals accept to register each other as the designated ride share members.

11. A system for intermediating user terminals to share vehicles, the system comprising:
at least one processor implemented to execute computer readable instructions, and
the at least one processor comprises:
a registering circuit configured to:
receive departure point information, destination information, time a user is leaving work, set-up information, and condition information from terminals comprising a provider terminal and a user terminal to share a provider vehicle with other people,
match the information with identifier information of corresponding terminals, and
register the matched information;
a determining circuit configured to determine at least one user terminal and at least one provider terminal matching each other based on the departure point information, the destination information, the time the user is leaving work, the set-up information, and the condition information of the terminals that transmitted an intermediation request; and
an information providing circuit configured to provide information of the matched at least one user terminal and the matched at least one provider terminal to each other.

12. The system of claim 11, wherein the determining circuit is configured to calculate matching possibility for time slots apart from the time the user is leaving work of the user terminal and the provider terminal for every predefined time unit, in response to failing to match at least one user terminal and the at least one provider terminal, and
wherein the information providing circuit is configured to provide the calculated matching possibility for each hour to the user terminal or the provider terminal.

13. The system of claim 12 further comprising a reward providing circuit configured to provide a reward for modifying time the user is leaving work in response to the at least one user terminal and the at least one provider terminal modifying the time the user is leaving work based on the received matching possibility for each time slots.

14. The system of claim 11, wherein the determination circuit is configured to determine whether the terminals are one of a provider terminal of a vehicle provider or a user terminal of a vehicle passenger in response to the corresponding set-up information.

15. The system of claim 11, wherein the determining circuit is configured to match at least one provider terminal and at least one user terminal which have closest matching time the user is leaving work in response to failing to match at least one user terminal and at least one provider terminal.

16. The system of claim 11, wherein the information providing circuit is configured to provide information regarding alternative route home in response to failing to match at least one user terminal and at least one vehicle provider, comprising relating to available taxis and off-duty vehicles service determined based on the departure point information, destination information, and time the user is leaving work of the user terminal when matching of the user terminal.

17. The system of claim 11, wherein the determining circuit is configured to determine pick up location and destination of the at least one user terminal based on the departure point information and destination information of the user terminal and relevant traffic regulations, and
the information providing unit is configured to provide the determined pick up location and destination of the at least one user terminal to the at least one user terminal and the at least one provider terminal.

18. The system of claim 11 further comprising a reward providing circuit configured to count a number of views of an advertisement provided in the user terminal and determine whether to provide a reward comprising a riding discount coupon or free riding coupon based on the counted number of views of the advertisement.

19. The system of claim 11, wherein the determining circuit configured to calculate remaining seat information, by
counting the number of at least one user terminal determined to ride the vehicle through matching with the at least one provider terminal, and
calculating remaining seat information based on vehicle capacity information received from the alt east one provider terminal and the counted number of user terminal, and
wherein the information providing circuit is configured to provide the calculated remaining seat information of matched at least one provider terminal to the matched at least one user terminal.

20. The system of claim 11, the determining circuit configured to:
determine terminals that had been successfully matched equal to or greater than a predefined certain frequency based on the past use history of the at least one provider terminal and the at least one user terminal, and
register the determined terminal as designated ride share members by confirming whether the users of the determined terminals accept to register each other as the designated ride share members.
